(19) United States
(12) Patent Application Publication
(10) Pub. No.: US 2025/0013287 A1
(43) Pub. Date: Jan. 9, 2025

(54) COORDINATING A CHANGE IN POWER STATE OF A SYSTEM BASIS CHIP WITH A CHANGE IN POWER STATE OF A PHY TRANSCEIVER IMPLEMENTED BY THE SYSTEM BASIS CHIP

(71) Applicant: Microchip Technology Incorporated, Chandler, AZ (US)

(72) Inventors: Venkatraman Iyer, Austin, TX (US); Hussein El-Shafie, Cork (IE); Hongming An, San Diego, CA (US)

(21) Appl. No.: 18/766,265

(22) Filed: Jul. 8, 2024

Related U.S. Application Data
(60) Provisional application No. 63/512,229, filed on Jul. 6, 2023.

(51) Int. Cl. G06F 1/3296; G06F 1/3206

(52) U.S. Cl. CPC G06F 1/3296; G06F 1/3206

(57) ABSTRACT

A method includes providing a system basis chip that supports at least two power states: a sleep state and an awake state; monitoring for power state information via a hardware interface and via a communication interface, wherein the hardware interface allows communication between a physical layer (PHY) transceiver implemented at the system basis chip and a PHY controller implemented at a microcontroller, and wherein the communication interface allows communication between the system basis chip and the microcontroller; and coordinating a change in power state of the system basis chip at least partially based on reception of power state information via the hardware interface and the communication interface.

### CROSS-REFERENCE TO RELATED APPLICATION

This application claims the benefit under 35 U.S.C. § 119 (e) of U.S. Provisional Patent Application Ser. No. 63/512,229, filed Jul. 6, 2023, the disclosure of which is hereby incorporated herein in its entirety by this reference.

### FIELD

Examples relate, generally, to system-basis-chips and system basis chips that implement physical layer devices.

### BACKGROUND

A system basis chip (SBC) is an integrated circuit (IC) that combines multiple functions required for the operation of electronic systems. ICs and SBCs are utilized in a variety of operational context.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of a system that implements, among other things, a 10SPE PHY, in accordance with one or more examples.

FIG. 2 is a block diagram depicting a system basis chip portion, in accordance with one or more examples.

FIG. 3 is a state diagram depicting transitions between wake and sleep states managed by an FSM of an SBC, in accordance with one or more examples.

FIG. 4 is a state diagram depicting staged power state changes from wake to sleep and from sleep to wake, managed by FSM of an SBC, in accordance with one or more examples.

FIG. 5 illustrates an example process to change a power state of a system basis chip that implements a PHY transceiver of a PHY having a split-PHY architecture, in accordance with one or more examples.

FIG. 6 is a flow chart depicting a process to coordinate a change in power state of an SBC that implements a PHY transceiver with a change in power state of the PHY transceiver, in accordance with one or more examples.

FIG. 7 illustrates an example process to change a power state of a system basis chip, a PHY transceiver implemented by the system basis chip, or both, in accordance with one or more examples.

FIG. 8 is a block diagram of circuitry that, in some examples, may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples of examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, steps, features, functions, or the like.

It will be readily understood that the components of the examples as generally described herein and illustrated in the drawing could be arranged and designed in a wide variety of different configurations. Thus, the following description of various examples is not intended to limit the scope of the present disclosure, but is merely representative of various examples. While the various aspects of the examples may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the examples disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer executes computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

As used herein, the terms “assert,” “de-assert” and derivatives thereof used in reference to a pin, means, respectively, to assert or de-assert a signal associated with the pin (e.g., a signal specifically assigned to the pin or a signal to which the pin is specifically assigned, without limitation).

A system basis chip (SBC) is an integrated circuit (IC) that combines multiple functions for the operation of an electronic system. An SBC typically integrates various different functions into a single chip. Examples of such functions include: power management functions such as voltage regulators, power switches, or protection circuitry, without limitation, to manage the power supply for the system; communication interfaces such as CAN (Controller Area Network), LIN (Local Interconnect Network), SPI (Serial Peripheral Interface), or I2C (Inter-Integrated Circuit); embedded systems, such as state machines or microprocessors, that control and coordinate tasks; analog functions such as analog-to-digital converters (ADCs), digital-to-analog converters (DACs), temperature sensors, and other signal conditioning circuitry; and diagnostic and safety functions, such as monitoring and reporting voltage levels, temperature, or fault conditions, without limitation.

SBCs are found in a variety of operational context, including automotive and industrial applications. A non-limiting example of an automotive application for SBC is in 10SPE (i.e., 10 Mbps Single Pair Ethernet) networks (also called “10BASE-TIS networks”). 10SPE is a network technology specified in IEEE 802.3 clauses 147 and 148. 10SPE is designed to provide a collision free, deterministic transmission on a multi-drop network.

In some cases, a transceiver (xcvr) and controller of a 10SPE physical layer device (PHY) may be located on different die, as a non-limiting example, so the respective dies may undergo different processing conditions. Such an architecture is referred to herein as a “split-PHY” architecture. In the split-PHY architecture, the digital blocks of a PHY controller, which are susceptible to damage during high-voltage, high-temperature processes (high-voltage, high-temperature processes are also referred to herein as “high voltage temperature processes”) may be located on a first die that does not undergo high voltage temperature processes. Analog and digital blocks of a PHY transceiver, which are not susceptible to damage during high voltage temperature processes or that require such high voltage temperature processes may be located on a second die that does undergo such processes.

The 10SPE Transceiver Interface standard currently under specification development by Technology Committee 14 of the Open Alliance (hereinafter the “TC14”) defines a 3-pin hardware interface for communication between a PHY transceiver and PHY controller.

In a PHY having a split-PHY architecture, the 10SPE controller functions are implemented at a microcontroller (MCU) and the 10SPE transceiver functions are implemented at an SBC. In addition to 10SPE transceiver functions, the SBC can implement non-transceiver functions, i.e., functions of the electronic system, such as power management, watchdog circuit, monitors, sensors, general purpose input/output (GPIO), without limitation. Thus, in 10SPE, an SBC's responsibilities may include, without limitation, communication transceiver, low-voltage power, observability/control of a high voltage domain, and functional safety mechanisms for the MCU to reach safe state.

Further, TC14 describes low-power (sleep-wake) behavior of the PHY transceiver for partial networking. Partial networking refers to a feature that enables selective power management and communication capabilities within a network. Partial networking allows certain network nodes or devices to enter a low-power state or sleep state while still maintaining basic communication functionality. In Ethernet networks, partial networking may be utilized to optimize (e.g., reduce, without limitation) power consumption, particularly in automotive or industrial applications. Allowing selected devices to enter a low-power state or sleep state may reduce overall power consumption, extend battery life, or improves energy efficiency, without limitation.

An SBC may implement a 10SPE PHY transceiver, and may also manage other functions such as power delivery and watchdog for the MCU, PHY controller, and other devices (such as sensors, without limitation). The drivers (e.g., firmware, configurable state machines, logic circuits, or hardware, without limitation) that implement a PHY transceiver and commands are typically separate (e.g., different datapaths, without imitation) and asynchronous with the drivers that implement other SBC functions.

In the case of power state management (e.g., of the PHY transceiver and MCU, without limitation), lack of coordination may cause inefficiencies, increased power consumption, and operational anomalies such as unintended wake-ups or failures to enter low-power states correctly.

Accordingly, it is challenging to manage coordinated power states and/or coordinated power state transitions in split-PHY architectures where the PHY transceiver and PHY controller are implemented separately on different components (e.g., on an SBC and an MCU, without limitation).

One or more examples relate, generally, to an SBC capable of coordinating changed in power state of the SBC with changes in power state of a PHY transceiver implemented by the SBC.

In one or more examples, the SBC implements at least a portion of the hardware interface between the PHY transceiver and PHY controller (e.g., the 3-pin hardware interface, without limitation) and implements the PHY transceiver, and so the SBC is at least generally aware of power state information (e.g., power management commands and status information, without limitation) transferred via the hardware interface. As a non-limiting example, while wake is handled exclusively by the PHY transceiver, information about wake source status is transferred via the hardware interface. Thus, the SBC is generally aware of a power state of the PHY transceiver and changes in power state. Further, provision of power to an MCU and the PHY controller implemented by the MCU is at least partially managed via information and commands transferred between the SBC and MCU over a communication interface (e.g., an I2C bus, without limitation).

In one or more examples, the SBC executes a power management command only when matching power management commands are received via the hardware interface (e.g., TC14 compliant three-pin hardware interface that enables communication between the PHY controller and the PHY transceiver, without limitation) and the I2C bus. This ensures that the SBC and PHY transceiver change power state concurrently. For example, the SBC, at substantially the same time, instructs changes in power states to the drivers that control power functions of the SBC and the drivers that implement the PHY transceiver. In some examples, the SBC may include a logic circuit (e.g., a finite-state-machine (FSM), without limitation) that stages changes in power state of the SBC and transceiver.

Accordingly, if a power management command is a command to sleep then power is not turned off at the SBC unless the power state management logic determines that both the PHY transceiver and the PHY controller are in (or will be in) a sleep state. So, a change in power state at the SBC is at least partially dependent upon power states, or planned power states, of the PHY transceiver and PHY controller.

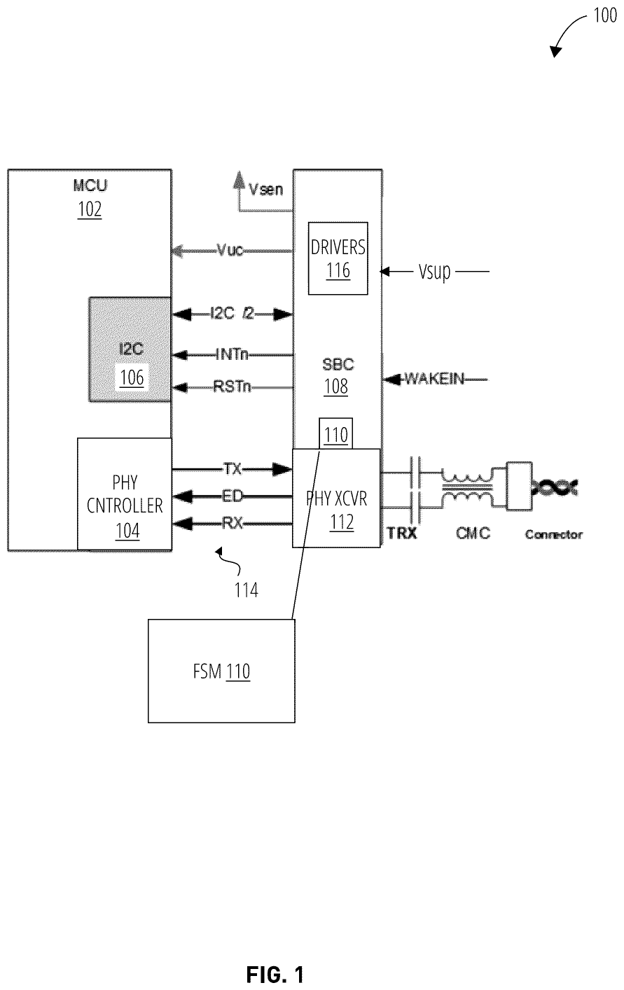

FIG. 1 is a block diagram of a system 100 that implements, among other things, a 10SPE PHY, in accordance with one or more examples.

The system 100 comprises an MCU 102 and an SBC 108. The MCU 102 includes a PHY controller 104 and an I2C bus controller 106. The SBC 108 includes a staged low-power entry and exit FSM 110 and a PHY transceiver 112. The PHY controller 104 and PHY transceiver 112 form a 10SPE PHY. The PHY controller 104 and PHY transceiver 112 communicate via the hardware interface 114 that includes connections for carrying signals associated with transmission signaling (TX connection), energy detection signaling (ED connection), and reception signaling (RX connection). The SBC and MCU communicate via an I2C bus and a command, control, and management connections (the command, control and management connections are represented by connections INTn, and RSTn, which specifically indicate action needed from the MCU, but are not intended to limit this disclosure in any way).

PHY controller 104 is responsible for managing the digital aspects of the 10BASE-TIS PHY communication. It handles tasks such as encoding, decoding, and managing the link layer protocols. I2C bus controller 106 manages communication over the I2C bus, facilitating command, control, and data exchange between the MCU and the SBC. In the specific example depicted by FIG. 1, the logic that manages communication between command, control, and management connections (e.g., INTn and RSTn, without limitation) is represented by the same block that represents the I2C bus controller 106, but may be a different logical partition.

SBC 108 implements or manages functions of the PHY transceiver 112, functions of the MCU 102, functions of sensors (sensors not depicted, but should be considered optional), and its own internal functions (SBC functions). Vuc is a supply voltage provided to the MCU from the SBC. Vsen is supply voltage provided to one or more sensors in the case where sensors are present. Vsup is the supply voltage provided to the SBC and may be utilized to produce Vuc and Vsen, e.g., directly or as a regulated version of Vsup. GPIO is a general-purpose input/output connection. Transmit/receive connections, common mode choke (CMC), and connector are physical circuits that connect SBC 108 to a physical transmission medium such as a twisted-pair, without limitation. WAKEIN is an input connection exclusively utilized to receive power management signals (e.g., wake or sleep, without limitation) from an external source (e.g., external to system 100, without limitation).

In one or more examples, SBC 108 coordinates power states and power state changes of two or more of: SBC 108, MCU 102, PHY controller 104 and PHY transceiver 112. SBC 108 includes a logic circuit, here FSM 110, to manage changes in the power state of the SBC in a staged manner (e.g., to prevent abrupt changes that could lead to system instability or increased power consumption, without limitation), as described below.

FSM 110 receives power state information (e.g., commands or status information, without limitation) via both the hardware interface 114 and the I2C bus, and utilizes the power state information to ensure that changes in the power state of the SBC 108 occur synchronously with changes in power state of the PHY transceiver 112. FSM 110 acts as a control logic that dictates the overall power state changes of SBC 108 and PHY transceiver 112. FSM 110 issues commands to drivers 116 (which includes SBC's drivers and drivers that implement the PHY transceiver 112), based on its state and the inputs it receives. Drivers 116 execute the detailed commands issued by FSM 110. For example, drivers 116 of the SBC 108 adjust the hardware settings, manage power regulation, and ensure that the system components follow the instructions from the FSM 110 accurately.

In the time period between when power state information indicating the SBC 108 should change power states and power state information indicating the PHY transceiver 112 should change power states, the SBC 108 or PHY transceiver 112, as the case may be, may handle events that occur during that period of time, such as wake events, without limitation.

In some examples, SBC 108 may include at least one regulated voltage source, and the sleep state of the SBC represents the at last one regulated voltage source being OFF, and the awake state of the SBC 108 represents the at least one regulated voltage source being ON.

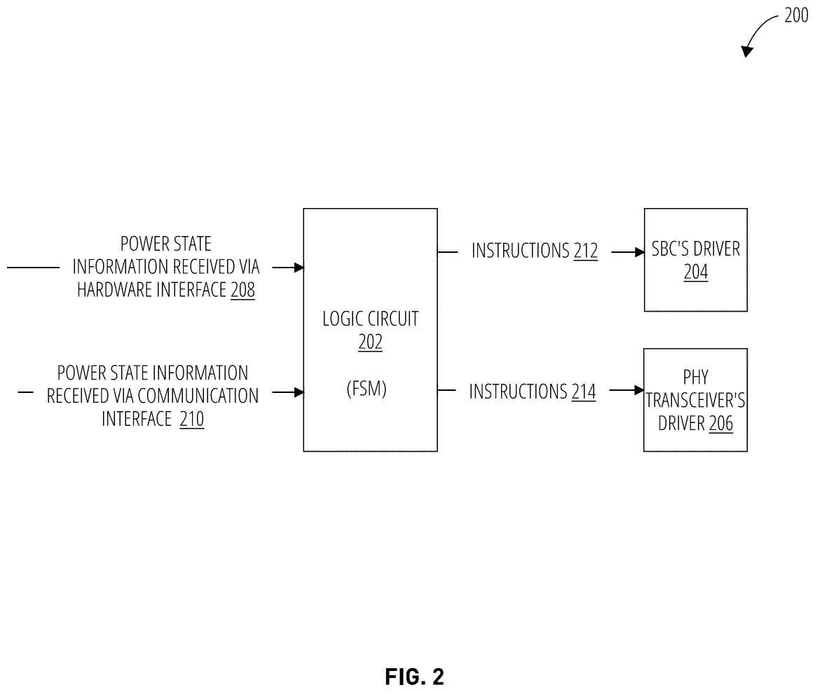

FIG. 2 is a block diagram depicting a system basis chip portion 200, in accordance with one or more examples. System basis chip portion 200 is a non-limiting example of a portion of SBC 108 of FIG. 1.

System basis chip portion 200 includes logic circuit 202, SBC's driver 204 and PHY transceiver's driver 206.

Logic circuit 202 monitors a hardware interface (e.g., hardware interface 114 of FIG. 1, without limitation) and a communication interface (e.g., communication interface I2C bus of FIG. 1, without limitation) for power state information, and receives power state information received via hardware interface 208 and power state information received via communication interface 210.

Power state information received via hardware interface 208 may include, as non-limiting examples, commands related to a power state of PHY transceiver 112 from PHY controller 104 to PHY transceiver 112 and other information indicative of power state or changes in power state at PHY transceiver 112. For example, a sleep command may be communicated from PHY controller 104 to PHY transceiver 112 via hardware interface 114, and power state information received via hardware interface 208 may include the sleep command.

Power state information received via communication interface 210 may include, as non-limiting examples, a directive (command) to the SBC that includes system basis chip portion 200 to enter a low power state or a sleep state.

SBC's driver 204 (a “first driver”) implements functions of the system basis chip including, without limitation, to execute instructions 212 from the logic circuit 202 (or FSM), such as adjusting hardware settings, handling communications over specific connections, and managing power regulation, without limitation. PHY transceiver's driver 206 (a “second driver”) implements functions of the PHY transceiver, including, without limitation, to execute instructions 214 from logic circuit 202.

Timing of instructions 212 and instructions 214 that include power state information and specific instructions to change power states or intermediate states may occur at substantially the same time. Here, “substantially the same time” when discussing provision of power state information or instructions more generally to both SBC's driver 204 and PHY transceiver's driver 206 means within a time window that ensures suitably synchronized state change, typically on the order of microseconds, to maintain system stability and power efficiency.

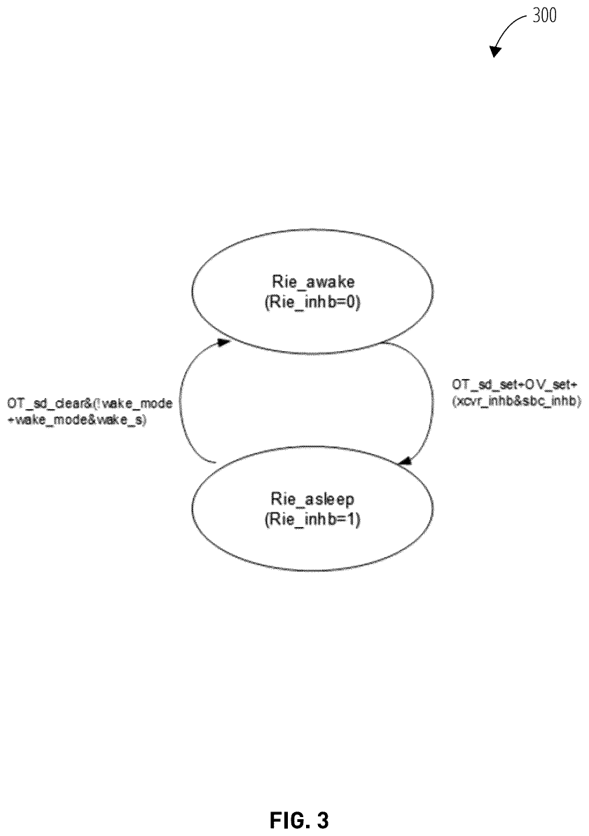

FIG. 3 is a state diagram depicting transitions between wake and sleep states managed by an FSM 110 of SBC 108, in accordance with one or more examples.

The awake state (WAIT_SLEEP) is an initial active state where the system is fully powered and operational. In this state, both the PHY transceiver and the MCU are awake, handling regular communication and processing tasks. While in an Awake State, the FSM 110 monitors for sleep commands from either the hardware interface (PHY transceiver) or the I2C bus (MCU).

Upon receiving sleep command, the FSM 110 will initiate the transition to the sleep state (WAIT_SLEEP to SLEEP) when both the sleep command from the reception signaling (RX) and the sleep command from the I2C bus are received (this condition is depicted in FIG. 3 as the expression SLEEP_CMD_RX && SLEEP_CMD_I2C). The transition from awake state to sleep state involves several intermediate stages (transitions through various intermediate states between WAIT_SLEEP and SLEEP) to ensure a controlled reduction in power consumption and to prevent abrupt changes that could cause instability, as discussed below. In this specific example, the FSM 110 waits for a low-dropout regulator (LDO) to turn off (WAIT_LDO_OFF) and for a general wait period (time period) before it completes the transition (these conditions are depicted in FIG. 3 as the expression WAIT_LDO_OFF && WAIT_SLEEP). Waiting for LDO to turn off and for a general wait period to expire are optional and conditions in addition to or different than these two conditions does not exceed the scope of this disclosure.

In the sleep state (SLEEP), the power consumption is minimized, and the SBC 108, and system 100 more generally, is ready to wake up in response to a wake event. When a wake event occurs (e.g., receipt of a wake command, without limitation), FSM 110 reverses the staged process to transition the system to the awake state (WAIT_SLEEP). The FSM 110 will initiate the transition to the awake state (SLEEP to WAIT_SLEEP) when either the wake command from the reception signaling (RX) or the wake command from the I2C bus is received (this condition is depicted in FIG. 3 as the expression WAKE_CMD_RX∥WAKE_CMD_I2C). In this specific example, the FSM 110 waits for the LDO to turn on (WAIT_LDO_ON) and for a general wait period before completing the transition to the awake state (these conditions are depicted in FIG. 3 as the expression WAIT_LDO_ON && WAIT_WAKE). Waiting for LDO to turn on and for a general wait period to expire are optional and conditions in addition to or different then these two conditions does not exceed the scope of this disclosure.

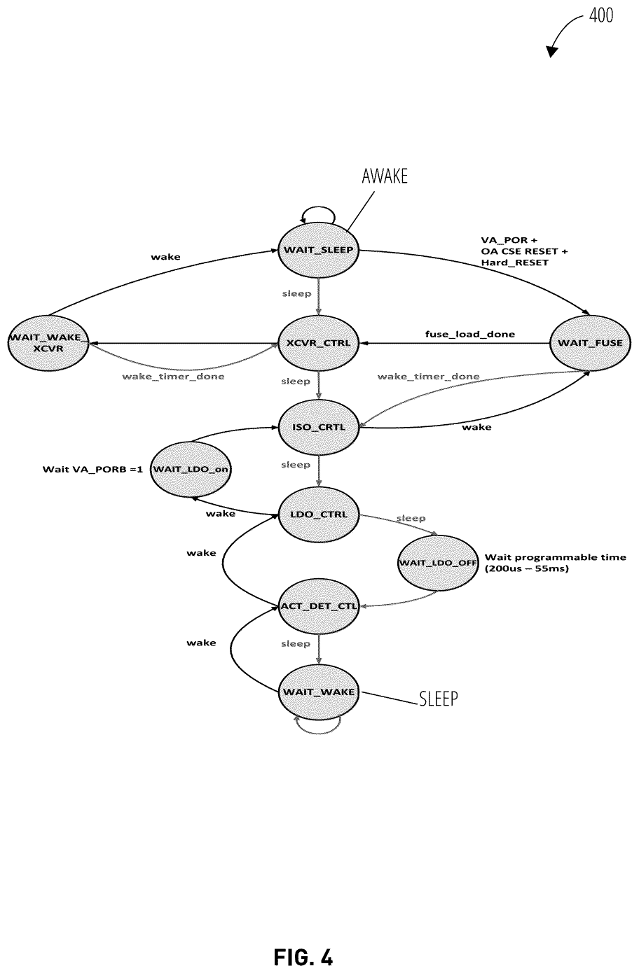

FIG. 4 is a state diagram depicting staged power state changes from wake to sleep and from sleep to wake, managed by FSM 110 of SBC 108, in accordance with one or more examples.

The staged power state change from awake to sleep includes the following states (states are identified by circles): WAIT_SLEEP (i.e., awake), XCR_CTL, ISO_CTRL, LDO_CTL, WAIT_LDO_OFF, ACT_DET_CTL, and WAIT_WAKE (i.e., asleep). Transitions between states are represented by arrows that point from a state to a next state. Conditions or events that trigger specific transitions are identified next to the arrows.

In the transceiver control state (XCR_CTL), the FSM configures PHY transceiver 112 with control settings to prepare for low-power mode. In isolation control state (ISO_CTL), FSM 110 isolates certain circuits to reduce power draw during awake to sleep transition, and reintegrates isolated circuits back into the system's power domain during sleep to awake transitions. In low-dropout regulator control state (LDO_CTL), the FSM 110 adjusts power regulation settings to lower power usage. In the wait for LDO to be off state (WAIT_LDO_OFF), the FSM 110 waits for confirmation that the LDO has successfully reduced or turned off its output. In the active detection control state, (ACT_DET_CTL) the FSM 110 ensures that any necessary monitoring for wake or sleep events remains functional, and reactivates detection circuits as needed. In the low power sleep state (WAIT_WAKE), the FSM 110 waits for a wake event. In the wait for LDO to be on state (WAIT_LDO_ON) the FSM waits for the LDO to stabilize and provide required voltage levels for normal operation.

The staged transition from awake to sleep includes the following state in sequence: WAIT_SLEEP, XCR_CTL, ISO_CTL, LDO_CTL, WAIT_LDO_OFF, ACT_DET_CTL, and WAIT_WAKE.

The staged transition from sleep to awake includes the following transitions in sequence: WAIT_WAKE, ACT_DET_CTL, WAIT_LDO_ON, ISO_CTRL, CVR_CTRL, WAIT_SLEEP.

These sequences ensure that power state transitions are smooth and coordinated, preventing sudden changes that could lead to instability or increased power consumption. The FSM 110 manages these staged transitions, ensuring each intermediate state is completed successfully before moving to the next state.

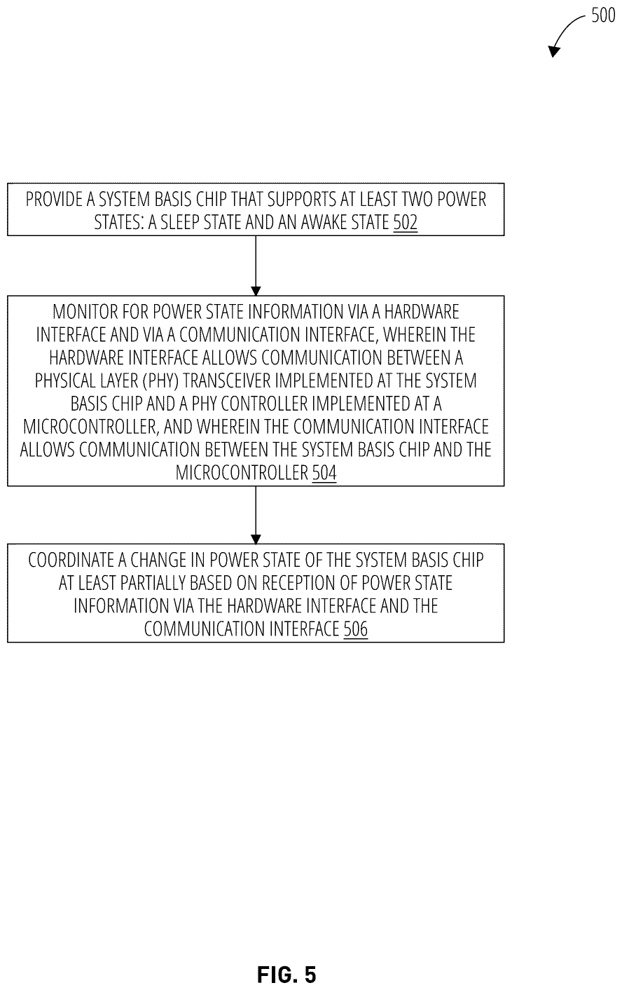

FIG. 5 illustrates an example process 500 to change a power state of a system basis chip that implements a PHY transceiver of a PHY having a split-PHY architecture, in accordance with one or more examples. Although the example process 500 depicts a particular sequence of operations, the sequence may be altered without departing from the scope of the present disclosure. For example, some of the operations depicted may be performed in parallel or in a different sequence that does not materially affect the function of the process 500. In other examples, different components of an example device or system that implements the process 500 may perform functions at substantially the same time or in a specific sequence. Some or a totality of operations of process 500 may be performed, as non-limiting examples, by system 100 or system basis chip portion 200.

According to one or more examples, process 500 may include providing a system basis chip that supports at least two power states: a sleep state and an awake state at operation 502.

According to one or more examples, process 500 may include monitoring for power state information via a hardware interface and via a communication interface, wherein the hardware interface allows communication between a physical layer (PHY) transceiver implemented at the system basis chip and a PHY controller implemented at a microcontroller, and wherein the communication interface allows communication between the system basis chip and the microcontroller, at operation 504.

According to one or more examples, process 500 may include coordinating a change in power state of the system basis chip at least partially based on reception of power state information via the hardware interface and the communication interface, at operation 506.

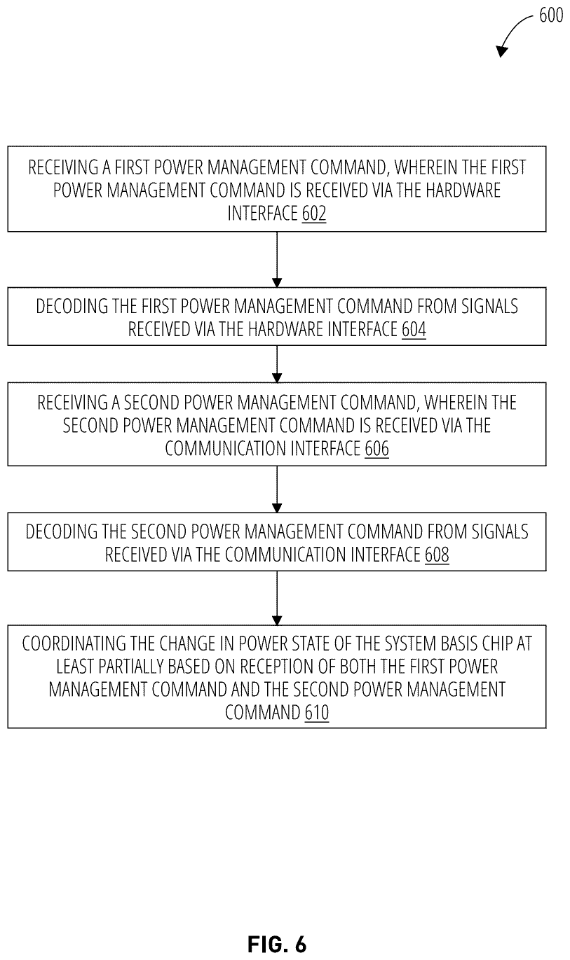

FIG. 6 is a flow chart depicting a process 600 to coordinate a change in power state of an SBC that implements an PHY transceiver with a change in power state of the PHY transceiver, in accordance with one or more examples. Although the example process 600 depicts a particular sequence of operations, the sequence may be altered without departing from the scope of the present disclosure. For example, some of the operations depicted may be performed in parallel or in a different sequence that does not materially affect the function of the process 600. In other examples, different components of an example device or system that implements the process 600, may perform functions at substantially the same time or in a specific sequence. Some or a totality of operations of process 600 may be performed, as non-limiting examples, by system 100 or system basis chip portion 200.

According to one or more examples, the method includes receiving a first power management command, wherein the first power management command is received via the hardware interface at operation 602.

According to one or more examples, the method includes decoding the first power management command from signals received via the hardware interface at operation 604.

According to one or more examples, the method includes receiving a second power management command, wherein the second power management command is received via the communication interface at operation 606.

According to one or more examples, the method includes decoding the second power management command from signals received via the communication interface at operation 608.

According to one or more examples, the method includes coordinating the change in power state of the system basis chip at least partially based on reception of both the first power management command and the second power management command at operation 610.

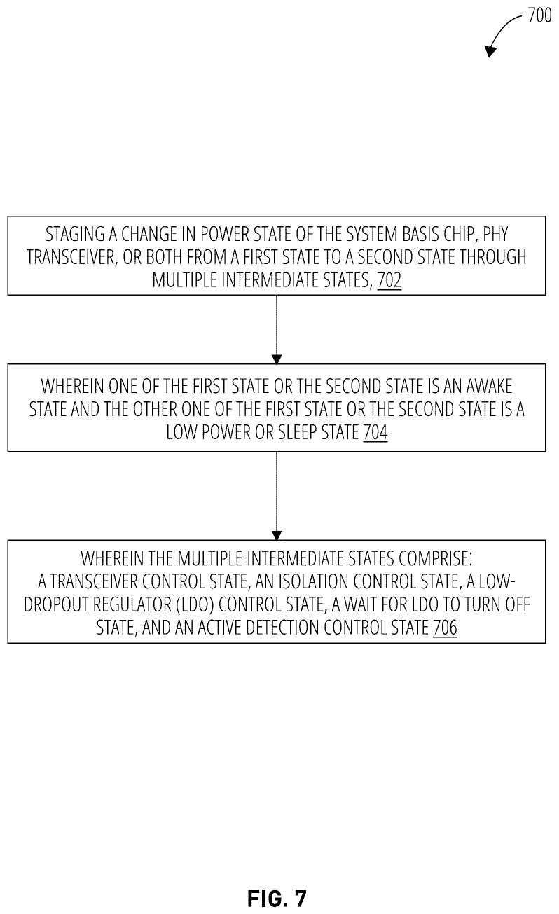

FIG. 7 illustrates an example process 700 to change a power state of a system basis chip, a PHY transceiver implemented by the system basis chip, or both, in accordance with one or more examples. Although the example process 700 depicts a particular sequence of operations, the sequence may be altered without departing from the scope of the present disclosure. For example, some of the operations depicted may be performed in parallel or in a different sequence that does not materially affect the function of the process 700. In other examples, different components of an example device or system that implements the process 700 may perform functions at substantially the same time or in a specific sequence. Some or a totality of operations of process 700 may be performed, as non-limiting examples, by system 100 or system basis chip portion 200.

According to one or more examples, process 700 may include staging a change in power state of the system basis chip from a first state to a second state through multiple intermediate states, at operation 702.

According to one or more examples, process 700 may include that one of the first state or the second state is an awake state and the other one of the first state or the second state is a sleep state, at operation 704.

According to one or more examples, process 700 may include that the multiple intermediate states comprise a transceiver control state, an isolation control state, a low-dropout regulator (LDO) control state, a wait for LDO to turn OFF state, and an active detection control state, at operation 706.

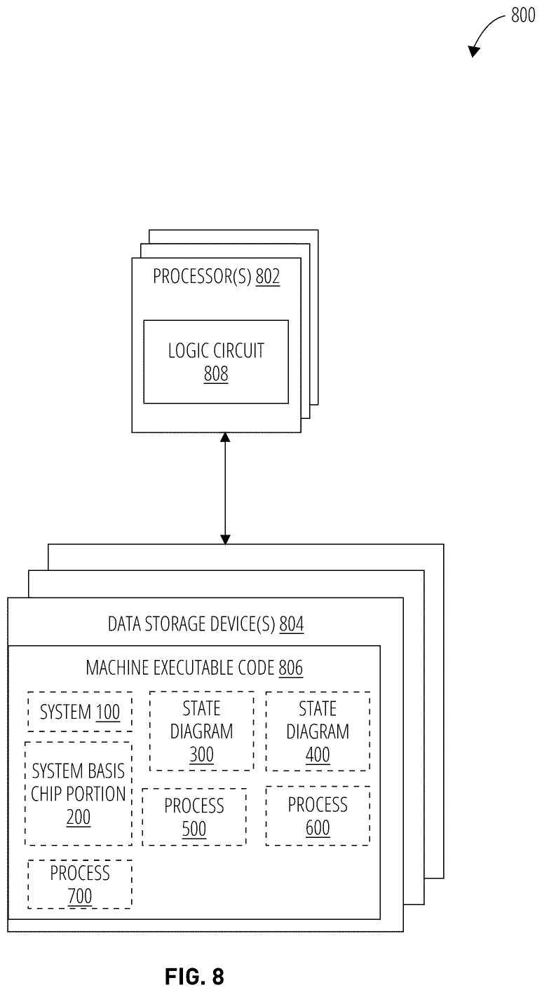

It will be appreciated by those of ordinary skill in the art that functional elements of examples disclosed herein (e.g., functions, operations, acts, processes, or methods) may be implemented in any suitable hardware, software, firmware, or combinations thereof. FIG. 8 illustrates non-limiting examples of implementations of functional elements disclosed herein. In some examples, some or all portions of the functional elements disclosed herein may be performed by hardware capable of carrying out the functional elements.

FIG. 8 is a block diagram of a circuitry 800 that, in some examples, may be used to implement various functions, operations, acts, processes, or methods disclosed herein. The circuitry 800 includes one or more processors 802 (sometimes referred to herein as “processors 802”) operably coupled to one or more data storage devices 804 (sometimes referred to herein as “storage 804”). The storage 804 includes machine executable code 806 stored thereon, and the processors 802 include logic circuit 808. The machine executable code 806 includes information describing functional elements that may be implemented by (e.g., performed by) the logic circuit 808. The logic circuit 808 is adapted to implement (e.g., perform) the functional elements described by the machine executable code 806. The circuitry 800, when executing the functional elements described by the machine executable code 806, should be considered as special purpose hardware for carrying out functional elements disclosed herein. In some examples, the processors 802 may perform the functional elements described by the machine executable code 806 sequentially, concurrently (e.g., on one or more different hardware platforms), or in one or more parallel process streams.

When implemented by logic circuit 808 of the processors 802, the machine executable code 806 adapts the processors 802 to perform operations of examples disclosed herein. By way of non-limiting example, the machine executable code 806 may adapt the processors 802 to perform some or a totality of operations of one or more of: process 500, process 600, or process 700; or processes that implement state diagram 300 or state diagram 400.

Also by way of non-limiting example, the machine executable code 806 may adapt the processors 802 to perform some or a totality of features, functions, or operations disclosed herein for one or more of: system 100, system basis chip portion 200, state diagram 300 or state diagram 400. More specifically, features, functions, or operations disclosed herein for coordinate changes in power state.

The processors 802 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine executable code 806 (e.g., software code, firmware code, hardware descriptions) related to examples of the present disclosure. It is noted that a general-purpose processor (may also be referred to herein as a host processor or simply a host) may be a microprocessor, but in the alternative, the processors 802 may include any conventional processor, controller, microcontroller, or state machine. The processors 802 may also be implemented as a combination of computing devices, such as a combination of a DSP and a microprocessor, a plurality of microprocessors, one or more microprocessors in conjunction with a DSP core, or any other such configuration.

In some examples, the storage 804 includes volatile data storage (e.g., random-access memory (RAM)), non-volatile data storage (e.g., Flash memory, a hard disc drive, a solid state drive, erasable programmable read-only memory (EPROM), without limitation). In some examples, the processors 802 and the storage 804 may be implemented into a single device (e.g., a semiconductor device product, a system on chip (SOC), without limitation). In some examples, the processors 802 and the storage 804 may be implemented into separate devices.

In some examples, the machine executable code 806 may include computer-readable instructions (e.g., software code, firmware code). By way of non-limiting example, the computer-readable instructions may be stored by the storage 804, accessed directly by the processors 802, and executed by the processors 802 using at least the logic circuit 808. Also by way of non-limiting example, the computer-readable instructions may be stored on the storage 804, transferred to a memory device (not shown) for execution, and executed by the processors 802 using at least the logic circuit 808. Accordingly, in some examples the logic circuit 808 includes electrically configurable logic circuit 808.

In some examples, the machine executable code 806 may describe hardware (e.g., circuitry) to be implemented in the logic circuit 808 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG®, SYSTEMVERILOG™ or very large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 808 may be described in an RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, the machine executable code 806 may include an HDL, an RTL, a GL description, a mask level description, other hardware description, or any combination thereof.

In examples where the machine executable code 806 includes a hardware description (at any level of abstraction), a system (not shown, but including the storage 804) implements the hardware description described by the machine executable code 806. By way of non-limiting example, the processors 802 may include a programmable logic device (e.g., an FPGA or a PLC) and the logic circuit 808 may be electrically controlled to implement circuitry corresponding to the hardware description into the logic circuit 808. Also by way of non-limiting example, the logic circuit 808 may include hard-wired logic manufactured by a manufacturing system (not shown, but including the storage 804), according to the hardware description of the machine executable code 806.

Regardless of whether the machine executable code 806 includes computer-readable instructions or a hardware description, the logic circuit 808 is adapted to perform the functional elements described by the machine executable code 806 when implementing the functional elements of the machine executable code 806. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:
Example 1: A method, comprising: providing a system basis chip that supports at least two power states: a sleep state and an awake state; monitoring for power state information via a hardware interface and via a communication interface, wherein the hardware interface allows communication between a physical layer (PHY) transceiver implemented at the system basis chip and a PHY controller implemented at a microcontroller, and wherein the communication interface allows communication between the system basis chip and the microcontroller; and coordinating a change in power state of the system basis chip at least partially based on reception of power state information via the hardware interface and the communication interface.
Example 2: The method according to Example 1, wherein monitoring for power state information includes monitoring for: power management commands and status information about power states.
Example 3: The method according to Examples 1 and 2, wherein coordinating the change in power state of the system basis chip comprises: coordinating the change in power state of the system basis chip with a change in power state of the PHY transceiver.
Example 4: The method according to Examples 1 to 3, wherein coordinating the change power state of the system basis chip with the change in power state of the PHY transceiver comprises providing at substantially the same time: first power state information to one or more drivers that manage the power state of the system basis chip; and second power state information to one or more drivers that manage the power state of the PHY transceiver.
Example 5: The method according to Examples 1 to 4, comprising: receiving a first power management command, wherein the first power management command is received via the hardware interface; receiving a second power management command, wherein the second power management command is received via the communication interface; and coordinating the change in power state of the system basis chip at least partially based on reception of both the first power management command and the second power management command.
Example 6: The method according to Examples 1 to 5, comprising: decoding the first power management command from signals received via the hardware interface; and decoding the second power management command from signals received via the communication interface.
Example 7: The method according to Examples 1 to 6, wherein the power state of the system basis chip does not change responsive to only one of the first power management command or the second power management command.
Example 8: The method according to Examples 1 to 7, wherein both the first power management command and the second power management command respectively comprise: a wake command or a sleep command.
Example 9: The method according to Examples 1 to 8, wherein the communication interface is separate and distinct from the hardware interface.
Example 10: The method according to Examples 1 to 9, wherein the PHY transceiver and the PHY controller together form a 10SPE PHY having a split-PHY architecture.
Example 11: The method according to Examples 1 to 10, comprising: staging a change in power state of the system basis chip from a first state to a second state through multiple intermediate states, wherein one of the first state or the second state is an awake state and the other one of the first state or the second state is a sleep state.
Example 12: The method according to Examples 1 to 11, wherein the multiple intermediate states comprise: a transceiver control state, an isolation control state, a low-dropout regulator (LDO) control state, a wait for LDO to turn OFF state, and an active detection control state.
Example 13: The method according to Examples 1 to 12, wherein the hardware interface for communication between the PHY transceiver and a PHY controller is integrated in the microcontroller.
Example 14: An apparatus, comprising: a first driver to implement functions of a PHY transceiver at a system basis chip; a second driver to implement functions of the system basis chip, the second driver different than the first driver; and a logic circuit to coordinate a change in power state of the system basis chip with a change in power state at the PHY transceiver via commands issued to the first driver and the second driver.
Example 15: The apparatus according to Example 14, wherein the system basis chip supports at least two power states: a sleep state and an awake state.
Example 16: The apparatus according to Examples 14 and 15, wherein the logic circuit to: monitor for power state information via a hardware interface and via a communication interface, wherein the hardware interface allows communication between the PHY transceiver implemented at the system basis chip and a PHY controller implemented at a microcontroller, and wherein the communication interface allows communication between the system basis chip and the microcontroller; and coordinate the change in the power state of the system basis chip with the change in power state of the PHY transceiver at least partially based on reception of power state information via both the hardware interface and the communication interface.
Example 17: The apparatus according to Examples 14 to 16, wherein the monitored power state information includes: power management commands and status information about power states.
Example 18: The apparatus according to Examples 14 to 17, wherein the logic circuit comprises: a finite-state-machine (FSM) to initiate a change in power state of the system basis chip at least partially based on power state information received via the hardware interface and the communication interface indicating a coordinated change in power state for the PHY transceiver.
Example 19: The apparatus according to Examples 14 to 18, wherein the logic circuit comprises: a finite-state-machine (FSM) to stage a change in power state of the system basis chip from a first state to a second state through multiple intermediate states, wherein one of the first state or the second state is an awake state and the other one of the first state or the second state is a sleep state.
Example 20: A system, comprises: a microcontroller; and a system basis chip that supports at least two power states: a sleep state and an awake state, wherein the system basis chip to: monitor for power state information via a hardware interface and via a communication interface, wherein the hardware interface allows communication between a PHY transceiver implemented at the system basis chip and a PHY controller implemented at the microcontroller, and wherein the communication interface allows communication between the system basis chip and the microcontroller; and coordinating a change in the power state of the system basis chip at least partially based on reception of power state information via both the hardware interface and the communication interface.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A method, comprising:
providing a system basis chip that supports at least two power states: a sleep state and an awake state;
monitoring for power state information via a hardware interface and via a communication interface, wherein the hardware interface allows communication between a physical layer (PHY) transceiver implemented at the system basis chip and a PHY controller implemented at a microcontroller, and wherein the communication interface allows communication between the system basis chip and the microcontroller; and
coordinating a change in power state of the system basis chip at least partially based on reception of power state information via the hardware interface and the communication interface.

2. The method of claim 1, wherein monitoring for power state information includes monitoring for: power management commands and status information about power states.

3. The method of claim 1, wherein coordinating the change in power state of the system basis chip comprises:
coordinating the change in power state of the system basis chip with a change in power state of the PHY transceiver.

4. The method of claim 3, wherein coordinating the change in power state of the system basis chip with the change in power state of the PHY transceiver comprises providing at substantially the same time:
first power state information to one or more drivers that manage the power state of the system basis chip; and
second power state information to one or more drivers that manage the power state of the PHY transceiver.

5. The method of claim 1, comprising:
receiving a first power management command, wherein the first power management command is received via the hardware interface;
receiving a second power management command, wherein the second power management command is received via the communication interface; and
coordinating the change in power state of the system basis chip at least partially based on reception of both the first power management command and the second power management command.

6. The method of claim 5, comprising:
decoding the first power management command from signals received via the hardware interface; and
decoding the second power management command from signals received via the communication interface.

7. The method of claim 5, wherein the power state of the system basis chip does not change responsive to only one of the first power management command or the second power management command.

8. The method of claim 5, wherein both the first power management command and the second power management command respectively comprise: a wake command or a sleep command.

9. The method of claim 1, wherein the communication interface is separate and distinct from the hardware interface.

10. The method of claim 1, wherein the PHY transceiver and the PHY controller together form a 10SPE PHY having a split-PHY architecture.

11. The method of claim 1, comprising:
staging a change in power state of the system basis chip from a first state to a second state through multiple intermediate states,
wherein one of the first state or the second state is an awake state and the other one of the first state or the second state is a sleep state.

12. The method of claim 11, wherein the multiple intermediate states comprise:
a transceiver control state, an isolation control state, a low-dropout regulator (LDO) control state, a wait for LDO to turn OFF state, and an active detection control state.

13. The method of claim 1, wherein the hardware interface for communication between the PHY transceiver and a PHY controller is integrated in the microcontroller.

14. An apparatus, comprising:
a first driver to implement functions of a PHY transceiver at a system basis chip;
a second driver to implement functions of the system basis chip, the second driver different than the first driver; and
a logic circuit to coordinate a change in power state of the system basis chip with a change in power state at the PHY transceiver via commands issued to the first driver and the second driver.

15. The apparatus of claim 14, wherein the system basis chip supports at least two power states: a sleep state and an awake state.

16. The apparatus of claim 14, wherein the logic circuit to:
monitor for power state information via a hardware interface and via a communication interface, wherein the hardware interface allows communication between the PHY transceiver implemented at the system basis chip and a PHY controller implemented at a microcontroller, and wherein the communication interface allows communication between the system basis chip and the microcontroller; and
coordinate the change in the power state of the system basis chip with the change in power state of the PHY transceiver at least partially based on reception of power state information via both the hardware interface and the communication interface.

17. The apparatus of claim 16, wherein the monitored power state information includes: power management commands and status information about power states.

18. The apparatus of claim 16, wherein the logic circuit comprises:
a finite-state-machine (FSM) to initiate a change in power state of the system basis chip at least partially based on power state information received via the hardware interface and the communication interface indicating a coordinated change in power state for the PHY transceiver.

19. The apparatus of claim 16, wherein the logic circuit comprises:
a finite-state-machine (FSM) to stage a change in power state of the system basis chip from a first state to a second state through multiple intermediate states,
wherein one of the first state or the second state is an awake state and the other one of the first state or the second state is a sleep state.

20. A system, comprises:
a microcontroller; and
a system basis chip that supports at least two power states: a sleep state and an awake state, wherein the system basis chip to:
monitor for power state information via a hardware interface and via a communication interface, wherein the hardware interface allows communication between a PHY transceiver implemented at the system basis chip and a PHY controller implemented at the microcontroller, and wherein the communication interface allows communication between the system basis chip and the microcontroller; and
coordinating a change in the power state of the system basis chip at least partially based on reception of power state information via both the hardware interface and the communication interface.
